(19) United States
(12) Patent Application Publication
(10) Pub. No.: US 2016/0086394 A1
(43) Pub. Date: Mar. 24, 2016

(54) DRIVING BEHAVIOR ANALYSIS METHOD AND SYSTEM THEREOF

(71) Applicant: YUAN ZE UNIVERSITY, Zhongli City (TW)

(72) Inventors: Chin-Sheng YANG, Pingzhen City (TW); Yung-Chih CHEN, New Taipei City (TW); Chia-Yu HSU, New Taipei City (TW); Liang-Chih YU, Zhongli City (TW); Pei-Chann CHANG, Zhongli City (TW); Kuo-Hua LAI, Taoyuan City (TW)

(21) Appl. No.: 14/569,255

(22) Filed: Dec. 12, 2014

(30) Foreign Application Priority Data
Sep. 24, 2014 (TW) 103133061

(51) Int. Cl. G07C 5/02; G07C 5/08

(52) U.S. Cl. CPC G07C 5/02; G07C 5/085

(57) ABSTRACT

A driving behavior analysis method and a system thereof are provided. The system includes a storage unit, a window splitting unit and a processing unit. The storage unit stores a history fuel-consumption sequence, a driving fuel-consumption sequence and a history reference unit. The history fuel-consumption sequence includes history fuel-consumption data and the driving fuel-consumption sequence includes current fuel-consumption data. The window splitting unit separates history fuel-consumption sequence into multiple basic units and separates driving fuel-consumption sequence into multiple consumption units by utilizing a sliding window to move on the two sequences. By ordering the history fuel-consumption data for each basic unit of the history fuel-consumption sequence in a decreasing order, the processing unit generates a decreasing fuel-consumption sequence. It performs a similarity comparison for the multiple fuel-consumption units and the multiple basic units of the decreasing fuel-consumption sequence, to calculate driving behavior feedback data.

### CROSS-REFERENCE TO RELATED APPLICATION

This application claims priority from Taiwan Patent Application No. 103133061, filed on Sep. 24, 2014, in the Taiwan Intellectual Property Office, the content of which are hereby incorporated by reference in their entirety for all purposes.

### BACKGROUND OF THE INVENTION

1. Field of the Invention

The following description relates to an analysis method and a system thereof, and more particularly, to a driving behavior analysis method and a system thereof using sequence analysis.

2. Description of the Related Art

Factors of human, vehicle and road impact greatly towards fuel-consumption and driving safety, and factor of human with respect to driving behavior of a driver plays the most critical role therein. Therefore, with the rising environmental protection and energy saving awareness, most of countries have been propelling notion of eco-driving, which is aimed at building the citizens a correct driving habit through the educational propaganda to the drivers to reach the direct effectiveness of fuel-consumption saving so as to accomplish the purpose of energy efficiency and carbon reduction.

In addition, the driving behavior varies with different driving styles and diverse driving habits, so even using the same automobile and driving on the same road, different drivers perform obvious difference owing to the various driving behaviors, and the diversity of driving behavior also leads to variation of the fuel-consumption of an automobile. As a result, energy-saving performance of automobile varies with different drivers.

The conventional analysis method of an aspect of driving behavior is to define initially the driving behavior (e.g. rush acceleration, sudden deceleration, constant speed and idle speed and so on) with respect to the fuel-consumption, and then to count the accumulated frequency or proportion happened in diverse behavior aspects in a driving course (e.g. how many times of rush acceleration happened or time proportion of rush acceleration), and finally the obtained statistics are served as the basis for discriminating good driving behavior from bad one, and the advice is provided accordingly. The method, however, is lacking in fidelity in terms of the driving behavior easily. For example, rush acceleration is generally regarded as an aspect of fuel-consumption driving, and regular judgment thereof is that when the driving speed is accelerated above a threshold value within a driving course, it is deemed as a driving behavior of rush acceleration. There are, nonetheless, many reasons causing acceleration (e.g. a steep downhill), of which may not necessarily be the fuel-consumption behavior. Take the constant speed which is generally considered as an aspect of eco-driving for another example, if the driving speed is maintained and the engine speed keeps rising, a steep uphill by any possibility, is contrarily a fuel-consumption driving behavior.

As a result, how to discriminate a fuel-saving driving aspect from a fuel-consumption one precisely has become an urgent to-be-solved technical problem.

### SUMMARY OF THE INVENTION

In aspect of the aforementioned technical problems, the present disclosure is to provide a driving behavior analysis method and a system thereof which utilize method of sequence analysis to accurately discriminate between a fuel-saving driving aspect and a fuel-consumption one.

In aspect of the aforementioned technical problems, the present disclosure is to provide a driving behavior analysis method and a system thereof which is capable of instantly generating driving behavior feedback data to a driver for reference when driving an automobile.

According to the preceding purpose, the present disclosure is to provide a driving behavior analysis method which may include the following steps: providing a user for a history fuel-consumption sequence and a driving fuel-consumption sequence while driving an automobile. The history fuel-consumption sequence may include history fuel-consumption data and the driving fuel-consumption sequence may include current fuel-consumption data when the automobile is driven in a unit distance; using a sliding window moving on the history fuel-consumption sequence to separate it into a plurality of basic units; performing a decreasing order according to the history fuel-consumption data of each of the plurality of basic units to generate a decreasing fuel-consumption sequence; using the sliding window moving on the driving fuel-consumption sequence to separate it into a plurality of fuel-consumption units; and performing a similarity comparison for the plurality of fuel-consumption units and the plurality of basic units of the decreasing fuel-consumption sequence to calculate driving behavior feedback data. When the similarity comparison of one of the plurality of fuel-consumption units matches one of the plurality of basic units of the decreasing fuel-consumption sequence, the driving behavior feedback data may generate promoting information according to the history fuel-consumption data of the basic unit.

Preferably, a driving behavior analysis method in accordance with present disclosure may further provide a plurality of history reference data corresponding to the plurality of basic units, and each of the plurality of history reference data may include a reference speed, a reference engine speed, a reference throttle position, a reference engine load and a reference air flow or a combination thereof.

Preferably, a driving behavior analysis method in accordance with present disclosure may further provide the plurality of driving reference data corresponding to the plurality of fuel-consumption units, and each of the plurality of references driving data may include a driving speed, a driving engine speed, a driving throttle position, a driving engine load and a driving air flow or a combination thereof.

Preferably, the similarity comparison may further include comparing the reference speed, the reference engine speed, the reference throttle position, the reference engine load and the reference air flow or a combination thereof with the driving speed, the driving engine speed, the driving throttle position, the driving engine load and the driving air flow or a combination thereof.

Preferably, the driving behavior feedback data may include a real-time energy-consumption degree estimation and prediction.

According to the preceding purpose, the present disclosure is to further provide a driving behavior analysis system which may include a storage unit, a window splitting unit and a processing unit. The storage unit may store a history fuel-consumption sequence, a driving fuel-consumption sequence and a plurality of history reference data of an automobile, the history fuel-consumption sequence may include history fuel-consumption data and the driving fuel-consumption sequence may include current fuel-consumption data when the automobile is driven in a unit distance, and each of the plurality of history reference data may correspond to a reference engine speed, a reference speed, a reference throttle position, a reference engine load and a reference air flow or a combination thereof when the automobile is driven in a unit distance. The window splitting unit may use a sliding window moving on the history fuel-consumption sequence and the driving fuel-consumption sequence to respectively separate that into a plurality of basic units and a plurality of fuel-consumption units. The processing unit may perform a decreasing order according to the history fuel-consumption data of each of the plurality of basic units to generate a decreasing fuel-consumption sequence, and perform a similarity comparison for the plurality of fuel-consumption units and the plurality of basic units of the decreasing fuel-consumption sequence to calculate driving behavior feedback data. When the similarity comparison of one of the plurality of fuel-consumption units matches one of the plurality of basic units of the decreasing fuel-consumption sequence, the driving behavior feedback data may generate promoting information according to the history fuel-consumption data of the basic unit.

Preferably, the storage unit may further include a plurality of history reference data corresponding to the plurality of fuel-consumption units, and each of the plurality of history reference data may include a reference speed, a reference engine speed, a reference throttle position, a reference engine load and a reference air flow or a combination thereof.

Preferably, the similarity comparison may further include comparing the reference speed, the reference engine speed, the reference throttle position, the reference engine load and the reference air flow or a combination thereof with the driving speed, the driving engine speed, the driving throttle position, the driving engine load and the driving air flow or a combination thereof.

Preferably, the driving behavior feedback data may include a real-time energy-consumption degree estimation and prediction.

Preferably, the driving behavior feedback data may be displayed on an event data recorder, a mobile device or a heads-up display.

### BRIEF DESCRIPTION OF THE DRAWINGS

Hereinafter, embodiments of the present disclosure will be described in detail with reference to the accompanying drawings so that those skilled in the art to which the present disclosure pertains can realize the present disclosure, where:

FIG. 1 is a block diagram of a driving behavior analysis system in accordance with an embodiment of the present disclosure.

FIG. 2A is the first schematic diagram of a driving behavior analysis system in accordance with an embodiment of the present disclosure.

FIG. 2B is the second schematic diagram of a driving behavior analysis system in accordance with an embodiment of the present disclosure.

FIG. 2C is the third schematic diagram of a driving behavior analysis system in accordance with an embodiment of the present disclosure.

FIG. 3 is a flow chart of a driving behavior analysis method in accordance with an embodiment of the present disclosure.

### DETAILED DESCRIPTION OF THE PREFERRED EMBODIMENTS

Hereinafter, embodiments of the present disclosure will be described in detail with reference to the accompanying drawings so that those skilled in the art to which the present disclosure pertains can realize the present disclosure. As those skilled in the art would realize, the described embodiments may be modified in various different ways, all without departing from the spirit or scope of the present disclosure.

The exemplary embodiments of the present disclosure will be understood more fully from the detailed description given below and from the accompanying drawings of various embodiments of the disclosure, which, however, should not be taken to limit the disclosure to the specific embodiments, but are for explanation and understanding only.

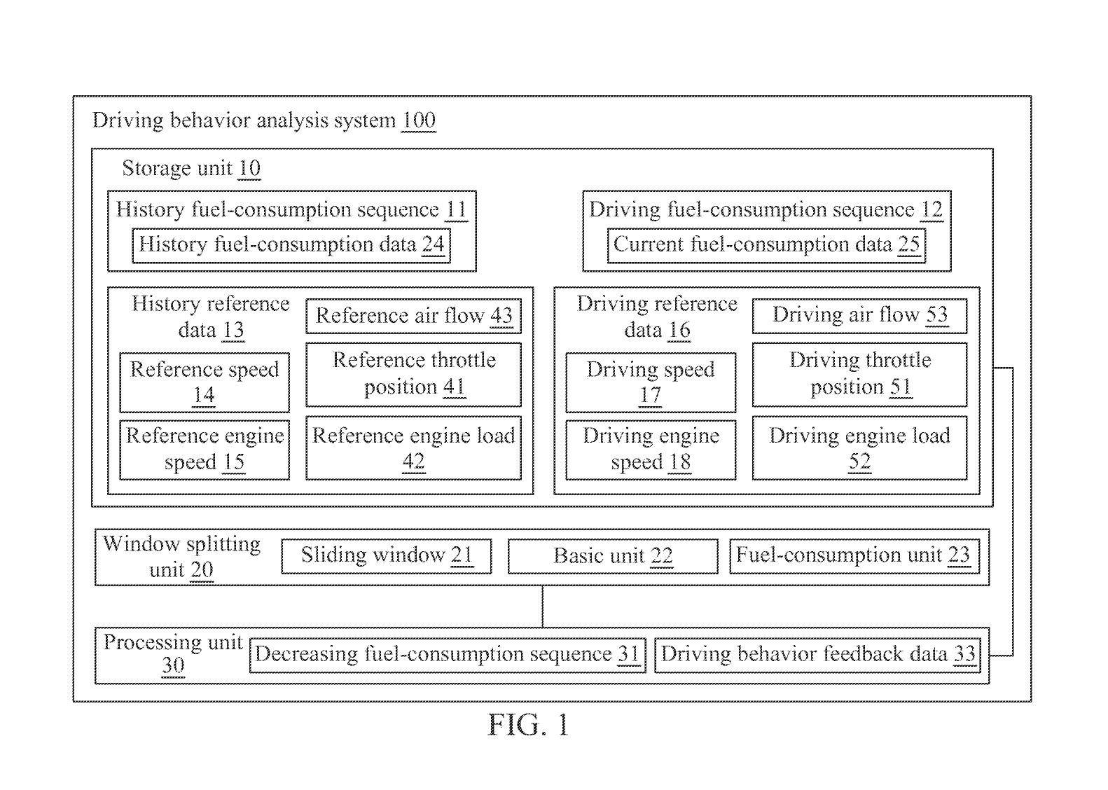

Please refer to FIG. 1 which is a block diagram of a driving behavior analysis system in accordance with an embodiment of the present disclosure. As the FIG. shows that a driving behavior analysis system 100 may include a storage unit 10, a window splitting unit 20 and a processing unit 30. Processing unit 30 may be electrically connected to storage unit 10 and window splitting unit 20. Storage unit 10 may be a .txt file, an electronic spreadsheet or a small database, and window splitting unit 20 and processing unit 30 may be software applications. Driving behavior analysis system 100 may be installed in an automobile electronic device or a smartphone.

Storage unit 10 may be configured to store a history fuel-consumption sequence 11, a driving fuel-consumption sequence 12, multiple history reference data 13 and multiple driving reference data 16. The history fuel-consumption sequence 11 may include history fuel-consumption data 24 and the driving fuel-consumption sequence 12 may include current fuel-consumption data 25 when an automobile is driven in a unit distance, and each of multiple history reference data 13 may correspond to a reference engine speed 15, a reference speed 14, a reference throttle position 41, a reference engine load 42 and a reference air flow 43 or a combination thereof when the automobile is driven in a unit distance in the history fuel-consumption sequence 11.

More specifically, the history fuel-consumption sequence 11 may be the different history fuel-consumption data indicating that the automobile is driven through different locations, and preferably, history fuel-consumption sequence 11 may be multiple history fuel-consumption data of two different locations such as the fuel-consumption record of destination from home to office within a month.

Window splitting unit 20 may use a sliding window 21 moving on history fuel-consumption sequence 11 and driving fuel-consumption sequence 12 to respectively separate that into multiple basic units 22 and multiple fuel-consumption units 23. The sliding window 21 may be a fixed size which may enable itself moving continuously on history fuel-consumption sequence 11 and driving fuel-consumption sequence 12. For example, if the history fuel-consumption sequence 11 is a fuel-consumption record of 1 km and window splitting unit 20 is a unit of 10 seconds. The first of multiple basic units 22 is the fuel-consumption within 0-10 seconds, the second is the fuel-consumption within 1-11 seconds . . . , and the n^{th} basic unit is the fuel-consumption within (n−1)-(n+9) seconds. Driving fuel-consumption sequence 12 may be separated into multiple fuel-consumption units 23 according to the aforementioned method.

Processing unit 30 may perform a decreasing order according to history fuel-consumption data 24 of each of multiple basic units 22 to generate a decreasing fuel-consumption sequence 31. In other words, one of multiple basic units 22 in the former section of decreasing fuel-consumption sequence 31 may save more fuels compared with latter section of decreasing fuel-consumption sequence 31. Following, processing unit 30 may perform a similarity comparison for multiple fuel-consumption units 23 and multiple basic units 22 of decreasing fuel-consumption sequence 31 to calculate driving behavior feedback data 33. When the similarity comparison of one of multiple fuel-consumption units 23 matches one of multiple basic units 22 of decreasing fuel-consumption sequence 31, the driving behavior feedback data 33 may generate promoting information according to history fuel-consumption data 24 of the basic unit 22, and driving behavior feedback data 33 may include a real-time energy-consumption degree estimation and prediction.

It is noteworthy that decreasing fuel-consumption sequence 31 may perform the decreasing order according to each of multiple basic units 22 of history fuel-consumption sequence 11, but driving belongs to a continuous movement, that is, each adjacent basic unit 22 of history fuel-consumption sequence 11 has correlation with each other. Hence, the driving aspect of the driver may only appear gradual increasing fuel-consumption, gradual decreasing fuel-consumption or stable fuel-consumption, and condition concerning that fuel-consumption of one of multiple basic units 22 is 18 km/l and next one becomes 5 km/l is impossible. Decreasing fuel-consumption sequence 31 provided in accordance with the present disclosure, however, is just used to reflect the driving aspect of the driver, Therefore, what the best condition of the present disclosure is that the order of partial multiple basic units 22 of decreasing fuel-consumption sequence 31 is namely equal to the order of the continuous multiple basic units 22 of history fuel-consumption sequence 11.

Multiple driving reference data 16 stored in storage unit 10 respectively correspond to multiple fuel-consumption units 23, and each of multiple driving reference data 16 may include a driving speed 17, a driving engine speed 18, a driving throttle position 51, a driving engine load 52 and a driving air flow 53 or a combination thereof corresponding to one of multiple fuel-consumption units 23.

When performing a similarity comparison, apart from comparing multiple fuel-consumption units 23 with multiple basic units 22 of decreasing fuel-consumption sequence 31, processing unit 30 may also include comparing reference speed 14, reference engine speed 15, reference throttle position 41, reference engine load 42 and the reference air flow 43 or a combination thereof with driving speed 17, driving engine speed 18, driving throttle position 51, driving engine load 52 and the driving air flow 53 or a combination thereof to boost precision of the comparison.

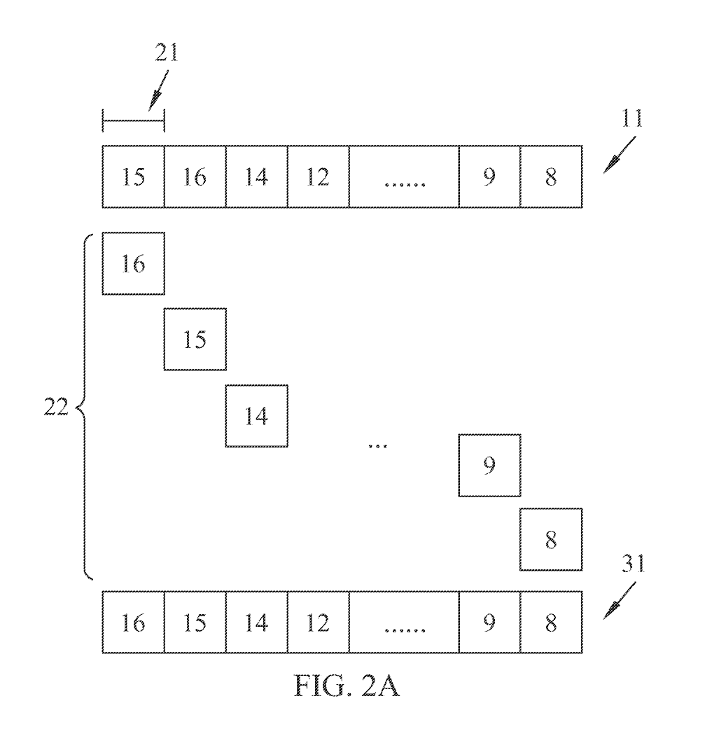

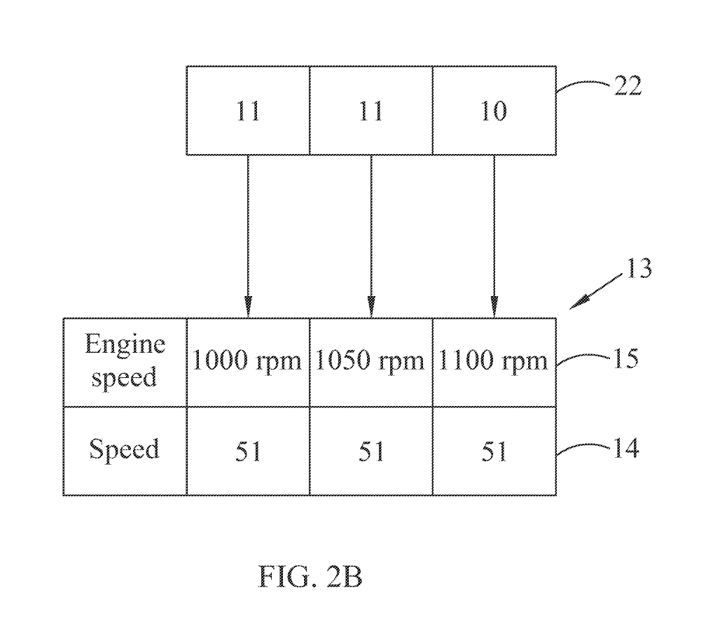

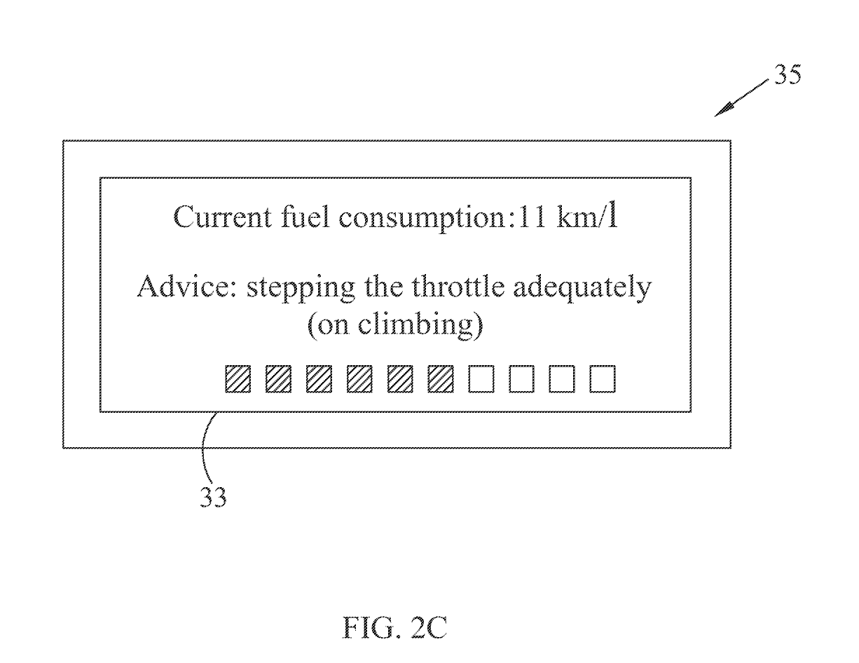

Please refer to FIG. 2A to FIG. 2C which are respectively the first, second and third schematic diagrams of a driving behavior analysis system in accordance with an embodiment of the present disclosure. Please refer to FIG. 1 together. Initially, FIG. 2A shows that history fuel-consumption sequence 11 of a driver is separated into multiple basic units 22 with the same size according to sliding window 21, and accordingly to generate a decreasing fuel-consumption sequence 31 according to fuel-consumption value of multiple basic units 22 through a decreasing order. In the embodiment, size of sliding window 21 is 10 seconds, and history fuel-consumption sequence 11 is therefore separated into multiple basic units 22 of 10 seconds. Data of each of multiple basic units 22 shown in the FIG. denotes a fuel-consumption value within 10 seconds such as “16” means that per liter gasoline performs 16 km within 10 seconds, and then multiple basic units 22 are performed decreasing order to generate decreasing fuel-consumption sequence 31.

When a user is driving, driving fuel-consumption sequence 12 of the moving automobile keeps generating and to be stored in storage unit 10 and driving fuel-consumption sequence 12 may be generated by a GPS calculating the automobile's driving distance, and then an oil quantity calculating device may be used to calculate the consumed oil quantity. Meanwhile, processing unit 30 may perform similarity comparison for driving fuel-consumption sequence 12 and decreasing fuel-consumption sequence 31, and the comparison method may use the size of each sliding window 21 as the comparison condition; namely, to compare each of multiple fuel-consumption units 23 of driving fuel-consumption sequence 12 with each of multiple basic units 22 of decreasing fuel-consumption sequence 31, but not limited to. A multiple of sliding window 21's size may also be served a comparison condition such as to compare the average fuel-consumption of every three of multiple basic units 22 of decreasing fuel-consumption sequence 31 with the average of every three of multiple fuel-consumption units 23 of driving fuel-consumption sequence 12.

More specifically, the comparison is to compare history reference data 13 and driving reference data 16 simultaneously. As FIG. 2B shows that when the fuel-consumption values of three of multiple basic units 22 are respectively 11 km/l, 11 km/l and 10 km/l, reference speed 14 of history reference data 13 are 51 km/h, 51 km/h and 51 km/h, reference engine speed 15 is 1000 rpm, 1050 rpm and 1100 rpm. It means that the automobile' engine speed rises and the fuel-consumption increases within 150 m, indicating that the climbing may happen. If values of multiple fuel-consumption units 23 of driving fuel-consumption sequence 12 are also 11 km/l, 11 km/l and 10 km/l, and driving speed 17 of driving reference data 16 and driving engine speed 18 are also equal to reference speed 14 and reference engine speed 15, processing unit 30 may accordingly generate driving behavior feedback data 33 which may be displayed on an event data recorder 35. The user may conduct adequate driving according to driving behavior feedback data 33. The schematic diagram can be referred to FIG. 2C.

The preceding embodiment is to compare reference speed 14 and reference engine speed 15 of history reference data 13 with driving speed 17 and driving engine speed 18 of driving reference data 16 as an example, but not limited to. It may also include comparing reference throttle position 41, reference engine load 42 and reference air flow 43 or a combination thereof with driving throttle position 51, driving engine load 52 and driving air flow 53 or a combination thereof.

By means of the method, it may avoid only using operational definition such as velocity of speed or quantity of engine speed to simply determine whether the driving aspect is fuel-saving; additionally, through the sequence analysis it may also provide the user for advice to make improvement. For example, the user may capture driving fuel-consumption sequence 12 and decreasing fuel-consumption sequence 31 via storage unit 10 to work out roads that consume more fuels, such as by means of changing throttle control or choosing an alternative road, or to collect diversity of history fuel-consumption sequence 11 and accordingly to generate common driving behavior feedback data 33. The collected information may be intensively applied to GPS for providing the driver for an optimal driving method while driving.

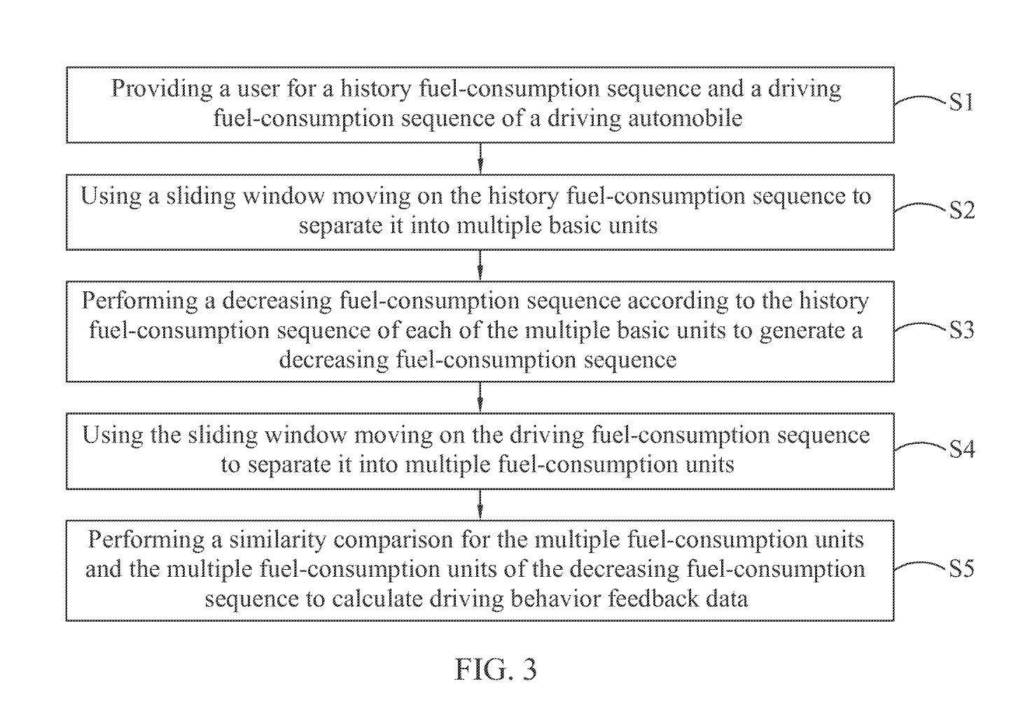

FIG. 3 is a flow chart of a driving behavior analysis method in accordance with an embodiment of the present disclosure. Please refer to FIG. 1 together. The driving behavior analysis method may include the following steps:

Step S1: providing a user for a history fuel-consumption sequence 11 and a driving fuel-consumption sequence 12 while driving an automobile 34. The history fuel-consumption sequence 11 may include history fuel-consumption data 24 and driving fuel-consumption sequence 12 may include current fuel-consumption data 25 when automobile 34 is driven in a unit distance.

Step S2: using a sliding window 21 moving on history fuel-consumption sequence 11 to separate it into multiple basic units 22.

Step S3: performing a decreasing order according to history fuel-consumption data 24 of each of multiple basic units 22 to generate a decreasing fuel-consumption sequence 31.

Step S4: using sliding window 21 moving on driving fuel-consumption sequence 12 to separate it into multiple fuel-consumption units 23.

Step S5: performing a similarity comparison for multiple fuel-consumption units 23 and multiple basic units 22 of decreasing fuel-consumption sequence 31 to calculate driving behavior feedback data 33. When the similarity comparison of one of multiple fuel-consumption units 23 matches one of multiple basic units 22 of decreasing fuel-consumption sequence 31, driving behavior feedback data 33 may generate promoting information according to history fuel-consumption data 24 of the basic unit 22.

Preferably, the method may further provide multiple history reference data 13 corresponding to the multiple basic units 22 and multiple driving reference data 16 corresponding to multiple fuel-consumption units 23, and each of the multiple history reference data 13 may include a reference speed 14, a reference engine speed 15, a reference throttle position 41, a reference engine load 42 and a reference air flow 43 or a combination thereof, and each of the multiple driving reference data 16 may include a driving speed 17, a driving engine speed 18, a driving throttle position 51, a driving engine load 52 and a driving air flow 53 or a combination thereof. The similarity comparison may further including comparing reference speed 14, reference engine speed 15, reference throttle position 41, reference engine load 42 and reference air flow 43 or a combination thereof with driving speed 17, driving engine speed 18, driving throttle position 51, driving engine load 52 and driving air flow 53 or a combination thereof.

While the means of specific embodiments in present disclosure has been described by reference drawings, numerous modifications and variations could be made thereto by those skilled in the art without departing from the scope and spirit of the disclosure set forth in the claims. The modifications and variations should in a range limited by the specification of the present disclosure.

What is claimed is:

1. A driving behavior analysis method, comprising:
providing a user for a history fuel-consumption sequence and a driving fuel-consumption sequence while driving an automobile, wherein the history fuel-consumption sequence comprises history fuel-consumption data and the driving fuel-consumption sequence comprises current fuel-consumption data when the automobile is driven in a unit distance;
using a sliding window moving on the history fuel-consumption sequence to separate it into a plurality of basic units;
performing a decreasing order according to the history fuel-consumption data of each of the plurality of basic units to generate a decreasing fuel-consumption sequence;
using the sliding window moving on the driving fuel-consumption sequence to separate it into a plurality of fuel-consumption units; and
performing a similarity comparison for the plurality of fuel-consumption units and the plurality of basic units of the decreasing fuel-consumption sequence to calculate driving behavior feedback data;
wherein when the similarity comparison of one of the plurality of fuel-consumption units matches one of the plurality of basic units of the decreasing fuel-consumption sequence, the driving behavior feedback data generates promoting information according to the history fuel-consumption data of the basic unit.

2. The driving behavior analysis method of claim 1, further comprising providing a plurality of history reference data corresponding to the plurality of basic units, and each of the plurality of history reference data comprising a reference speed, a reference engine speed, a reference throttle position, a reference engine load and a reference air flow or a combination thereof.

3. The driving behavior analysis method of claim 2, further comprising providing a plurality of driving reference data corresponding to the plurality of fuel-consumption units, and each of the plurality of driving reference data comprising a driving speed, a driving engine speed, a driving throttle position, a driving engine load and a driving air flow or a combination thereof.

4. The driving behavior analysis method of claim 3, wherein the similarity comparison further comprises comparing the reference speed, the reference engine speed, the reference throttle position, the reference engine load and the reference air flow or a combination thereof with the driving speed, the driving engine speed, the driving throttle position, the driving engine load and the driving air flow or a combination thereof.

5. The driving behavior analysis method of claim 1, wherein the driving behavior feedback data comprises a real-time energy-consumption degree estimation and prediction.

6. A driving behavior analysis system, comprising:
a storage unit configured to store a history fuel-consumption sequence, a driving fuel-consumption sequence and a plurality of history reference data of an automobile, the history fuel-consumption sequence comprising history fuel-consumption data and the driving fuel-consumption sequence comprising current fuel-consumption data when the automobile is driven in a unit distance, and each of the plurality of history reference data corresponding to a reference engine speed, a reference speed, a reference throttle position, a reference engine load and a reference air flow or a combination thereof when the automobile is driven in a unit distance;
a window splitting unit configured to use a sliding window moving on the history fuel-consumption sequence and the driving fuel-consumption sequence to respectively separate that into a plurality of basic units and a plurality of fuel-consumption units, and
a processing unit configured to perform a decreasing order according to the history fuel-consumption data of each of the plurality of basic units to generate a decreasing fuel-consumption sequence, and to perform a similarity comparison for the plurality of fuel-consumption units and the plurality of basic units of the decreasing fuel-consumption sequence to calculate driving behavior feedback data;
wherein when the similarity comparison of one of the plurality of fuel-consumption units matches one of the plurality of basic units of the decreasing fuel-consumption sequence, the driving behavior feedback data generates promoting information according to the history fuel-consumption data of the basic unit.

7. The driving behavior analysis system of claim 6, wherein the storage unit further comprises a plurality of history reference data corresponding to the plurality of fuel-consumption units, and each of the plurality of history reference data comprises a reference speed, a reference engine speed, a reference throttle position, a reference engine load and a reference air flow or a combination thereof.

8. The driving behavior analysis system of claim 7, wherein the similarity comparison further comprises comparing the reference speed, the reference engine speed, the reference throttle position, the reference engine load and the reference air flow or a combination thereof with the driving speed, the driving engine speed, the driving throttle position, the driving engine load and the driving air flow or a combination thereof.

9. The driving behavior analysis system of claim 6, wherein the driving behavior feedback data comprises a real-time energy-consumption degree estimation and prediction.

10. The driving behavior analysis system of claim 6, wherein the driving behavior feedback data is displayed on an event data recorder, a mobile device or a heads-up display.
